(19) United States
(12) Patent Application Publication
(10) Pub. No.: US 2022/0417032 A1
(43) Pub. Date: Dec. 29, 2022

(54) DISTRIBUTED SIGNING SYSTEM

(71) Applicant: ARRIS Enterprises LLC, Suwanee, GA (US)

(72) Inventors: Alexander MEDVINSKY, San Diego, CA (US); Tat Keung CHAN, San Diego, CA (US); Ting YAO, San Diego, CA (US)

(73) Assignee: ARRIS Enterprises LLC, Suwanee, GA (US)

(21) Appl. No.: 17/847,634

(22) Filed: Jun. 23, 2022

Related U.S. Application Data
(60) Provisional application No. 63/214,151, filed on Jun. 23, 2021.

(51) Int. Cl. H04L 9/32; H04L 9/08

(52) U.S. Cl. CPC H04L 9/3247; H04L 9/0894; H04L 9/0819

(57) ABSTRACT

A system and method for signing or encrypting data is disclosed. The method comprises providing, from a first device, data signing information for storage in a first database, the data signing information having at least one key comprising a signing key Ks, wherein the signing key Ks is encrypted according to a wrapping key Kw before storage in the first database; receiving a data signing request comprising a representation of the data; retrieving, in a second device communicatively coupled to an hardware security module (HSM) storing the wrapping key Kw, the stored data signing information from a second database, wherein at least a portion of the second database including the stored signing information is pushed from the first database to the second database; decrypting, in the HSM, the encrypted signing key according to the wrapping key Kw stored in the HSM to recover the signing key Ks; and signing the representation of the data according to the recovered signing key.

### CROSS REFERENCE TO RELATED APPLICATIONS

The present application claims priority to U.S. Provisional App. No. 63/214,151 filed Jun. 23, 2021, the contents of which are each incorporated herein by reference in their entirety.

### BACKGROUND

### 1. Field

The present invention relates to systems and methods for signing data for use on devices, and in particular to a system and method for providing distributed code signing services.

### 2. Description of the Related Art

It is beneficial in some circumstances to provide data to devices which have already been distributed to end users (e.g. fielded devices). Such data may be needed to update the device(s) to newer configurations or to perform additional functions, to ameliorate software “bugs” or other issues, or to simply replace data already resident in the device that may have been compromised. Such data may include software instructions (e.g. code) update fielded devices by providing data such as software code to those devices remotely.

One of the problems with the remote downloading of such data to fielded devices is that the data may be from an unauthorized source. An entity providing the data to the fielded devices may pose as a legitimate source of the data, yet provide data that is designed to compromise the security or functionality of the device. For example, the user of the device may be misled into believing that their device needs a software update in order to function properly, and may be provided a bogus uniform resource location (URL) from which to download the software update. If the user downloads and installs the software update from the bogus URL, the code that is actually downloaded may include a virus or other malware that negatively affects the operation of the device, perhaps compromising all of the data (including the user's private information) that was stored by the device before the infected.

To prevent the foregoing problems, code signing techniques can be used to digitally sign data such as executables and scripts. Such signatures confirm the identity of the author of the data and guarantee that the data has not been altered or otherwise corrupted since it was signed. Most code signing paradigms provide a digital signature mechanism to verify the identity of the author of the data or build system, and a checksum to verify that the data object has not been modified. Such code signing paradigms typically use authentication mechanisms such as public key infrastructure (PKI) technologies, which rely on data publishers securing their private keys against unauthorized access. The public key used to authenticate the data signature should be traceable back to a trusted root certificate authority (CA). If the data signature is traced to a CA that the device user trusts, the user is presumed to be able to trust the legitimacy and authorship of the data that is signed with a key generated by that CA.

Systems for code signing are known in the art. Such systems provide a framework that allows different organizations or companies to structure their data signing permission needs as they see fit or to safely permit data signing by other independent organizations.

However, uploading large images to a remote centralized system may be too slow, and while the availability of the code signing system is often critical to developers, connections to a remote centralized system may sometimes be unavailable or intermittent. Sometimes performance can be addressed by submitting a hash of the code to be signed by a code signing system. But in other cases, if that code also needs to be encrypted or a code header needs to be inspected or updated, the whole code image may need to be submitted to a code signing system with the above-mentioned performance implications. Further, if a centralized system goes down for some reason, and code cannot be signed, it may halt critical development, debugging and testing activities

At the same time, there are many positive aspects of a centralized code signing systems such as centralized and simplified management of users and configurations and ability to produce reports that cover all the users and code signing operations

What is needed is a system and method for signing software images and other information that provides the advantages of a centralized system, while providing desired responsiveness and availability.

### SUMMARY

To address the requirements described above, this document discloses a system and method for signing or encrypting data. In one embodiment, the method comprises providing, from a first device, data signing information for storage in a first database, the data signing information having at least one key comprising a signing key Ks, wherein the signing key Ks is encrypted according to a wrapping key Kw before storage in the first database; receiving a data signing request comprising a representation of the data; retrieving, in a second device communicatively coupled to an hardware security module (HSM) storing the wrapping key Kw, the stored data signing information from a second database, wherein at least a portion of the second database including the stored signing information is pushed from the first database to the second database; decrypting, in the HSM, the encrypted signing key according to the wrapping key Kw stored in the HSM to recover the signing key Ks; and signing the representation of the data according to the recovered signing key.

Another embodiment is evidenced by an apparatus having a processor and a communicatively coupled memory storing processor instructions for performing the foregoing operations.

The features, functions, and advantages that have been discussed can be achieved independently in various embodiments of the present invention or may be combined in yet other embodiments, further details of which can be seen with reference to the following description and drawings.

### BRIEF DESCRIPTION OF THE DRAWINGS

Referring now to the drawings in which like reference numbers represent corresponding parts throughout:

FIG. 1 is a diagram depicting one embodiment of an online code signing system (OCSS);

FIG. 2 is a diagram illustrating one embodiment of a manual process by which the designated users of the OCSS is used to sign data;

FIG. 3 is a diagram of an automated version of the OCSS;

FIG. 4 is a diagram depicting a hierarchical organization (e.g. hierarchy) of a plurality of entities associated with data signing operations;

FIG. 5 is a diagram depicting the hierarchical organization and the user roles associated with those entities;

FIG. 6 is a diagram of elements of a general purpose machine-to-machine code signing system;

FIG. 7 is a diagram illustrating the use of a client tool and a code signing system for use in signing software images and other data;

FIG. 8 is a diagram of one embodiment of a distributed code signing system;

FIG. 9 is a diagram illustrating further details of exemplary operations that can be used to sign data; and

FIG. 10 is a diagram illustrating an exemplary computer system that could be used to implement elements of the system.

### DESCRIPTION

In the following description, reference is made to the accompanying drawings which form a part hereof, and which is shown, by way of illustration, several embodiments. It is understood that other embodiments may be utilized and structural changes may be made without departing from the scope of the present disclosure.

### Overview

A distributed data signing architecture is described. The distributed data signing architecture provides much better server availability, up-time, and performance than a centralized solution. A local server will provide code signing and encryption services within an enterprise even while an Internet connection is not available. The local server typically handles less traffic since it is only handing local user requests, typically within one enterprise. Further, if a local security server does go down—it affects a smaller population of users than that of a failure of a central server. And users that are temporarily not able to access the local server will still have the option to login and request code signing directly from the central server. Also, use of the local security server allows the central server to receive much less request traffic than otherwise would be the case, because the local security server handles most such traffic, leaving most of the traffic handled by the central server to be administrators managing user accounts and code sign/encrypt configurations. The distributed data signing architecture is also much more scalable than a centralized architecture, since user requests are sent to local servers handling a much smaller population. Further, since user/configuration management is under the same centralized control, and clear keys are not exposed outside an hardware security module in distributed location of the local security servers, the distributed architecture offers security comparable to that of the centralized system.

The use of the distributed data signing architecture is summarized as follows. An administrator creates user accounts and code signing/encryption configurations via a central Cloud Security Service portal in a manner much same as in existing non-distributed system. User permissions are also managed centrally. Code encryption/signing keys that are securely stored in a hardware security module are encrypted and put into the database for later distribution to local security servers.

The central database is then pushed out to local security servers. Each local security server could receive the exact copy of the central database, or alternatively, each local server may only receive configuration and user account info that is configured for that specific local server or location. Therefore, if a particular customer is not intended to make use of a specific code signing configuration—that configuration will not be replicated to their server. Notably, the connectivity to local servers is not guaranteed and so this database synchronization may sometimes be delayed.

Once wrapped encryption/signing keys are pushed out to a local server, they are then loaded into an HSM and decrypted (unwrapped) inside the HSM. New keys can be unwrapped into an HSM once after a database update, or a key can be unwrapped into an HSM for every code signing/encryption operation and then erased from HSM volatile memory.

A user submits code (or code digest) for signing or encryption to a local security server. This can be accomplished via a manual GUI interface to upload the code/code hash, or using an automated interface using a command-line utility or an application programming interface (API).

The local security server returns the result of the operation (code signature, code with signature appended, encrypted code, encrypted and signed code. Finally, activity logs of code signing & encryption operations may be uploaded to the central database for later reporting purposes. When there is a connectivity issue, this update of the central database update might get delayed.

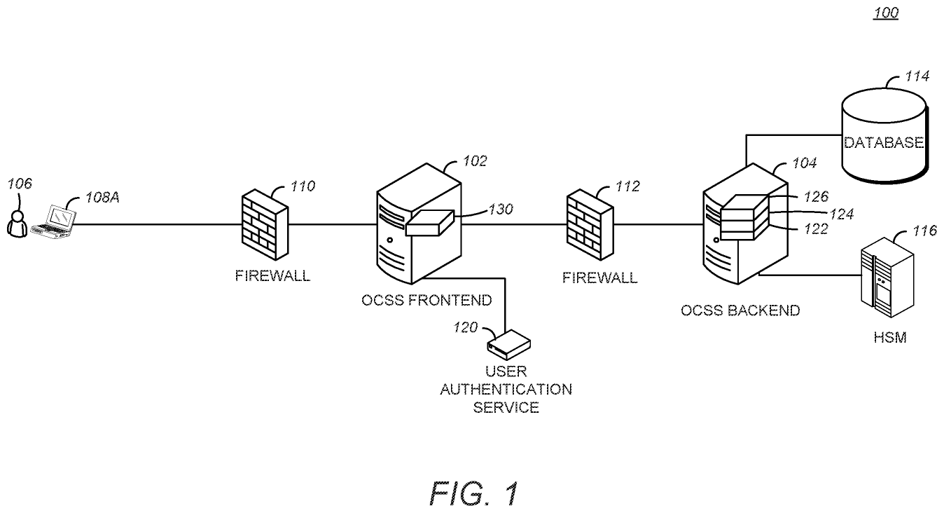

FIG. 1 is a diagram depicting an exemplary OCSS 100. The OCSS frontend 102 is a Graphic User Interface (GUI) layer that is the presentation layer for the OCSS 100. The OCSS frontend 102 is hosted on a server that is behind a firewall 110 to protect against unnecessary or unauthorized access. The OCSS frontend 102 comprises a web portal interface 130 that implements the presentation (e.g. “look and feel”) of functionality of the OCSS 100 on the user device 108A to an external user 106. In one embodiment, the web portal interface 130 is hosted in an Internet Information Service (IIS). Preferably, the OCSS frontend 102 does not enforce signing permissions, perform any signing or key generation activities, or define the hierarchy of the entities discussed below or how the access to such entities are managed. Rather, the OCSS frontend 102 controls access to the OCSS backend 104, and the OCSS backend 104 performs the functionality of enforcing signing permissions, performing signing or key generation activities, and/or defining the hierarchy of the entities discussed below and how the access to such entities are managed.

The OCSS frontend 102 also has access to a server operating according to a user authentication service such as an Lightweight Directory Access Protocol (LDAP) server to authenticate valid user device 108A. The OCSS 100 maintains its own database of user 106 accounts, and the OCSS User authentication service 120 is used when a user is added to the system for the first time and a user account is created and stored in the OCSS database 114.

To access the OCSS 100, the user 106 must specify user credentials, such as a password. Those credentials are used to validate every user session between the user and the OCSS frontend 102. The OCSS 100 forbids access to users 106 unless valid credentials are provided by the user device 108A and favorably compared to analogous information specified in OCSS database 114. Hence, only valid OCSS 100 users having credentials matching those stored in the OCSS database 114) are allowed to access OCSS 100.

The OCSS backend 104 is behind a second firewall 112 and provides protected access to the OCSS database 114 and the code signing keys that are stored in an OCSS hardware security module (HSM) 116. It is used to access the OCSS hierarchical entities discussed below and to look up user permissions for different code signing configurations and to perform all authorized crypto operations. The OCSS backend 104 connects to OCSS HSM 116 and using the OCSS HSM 116, performs operations such as code signing, encryption, and decryption. The OCSS backend 104 may implement a plurality of software layers including, from the top software layer to the bottom software layer, an OCSS Service Layer 126, a Business Logic Layer (BLL) 122 and a Data Access Layer (DAL) 124.

Although the foregoing discloses an OCSS 100 having a OCSS frontend 102 and an OCSS backend 104, the OCSS 100 may be implemented with a single server performing the functions of both the OCSS frontend 102 and the OCSS backend 104, albeit, with reduced security.

The OCSS Service Layer 126 is the heart of OCSS 100 and is comprised of a plurality of signing/generation operations that are supported by OCSS 100. Depending on what type of service is needed, a specific dynamically loadable library (DLL) required for that service may be injected into memory to perform the operation.

The Business Logic Layer (BLL) 122 specifies which users 106 have access to the OCSS 100 and the conditions on which access is granted or revoked. The BLL 122 also takes care of other business logic such as updating audit logs and generating reports.

The Data Access Layer (DAL) layer 124 provides access to the OCSS database 114 and enables queries to access, add or remove entries in the OCSS database 114.

### Manual Interactive Web Processes

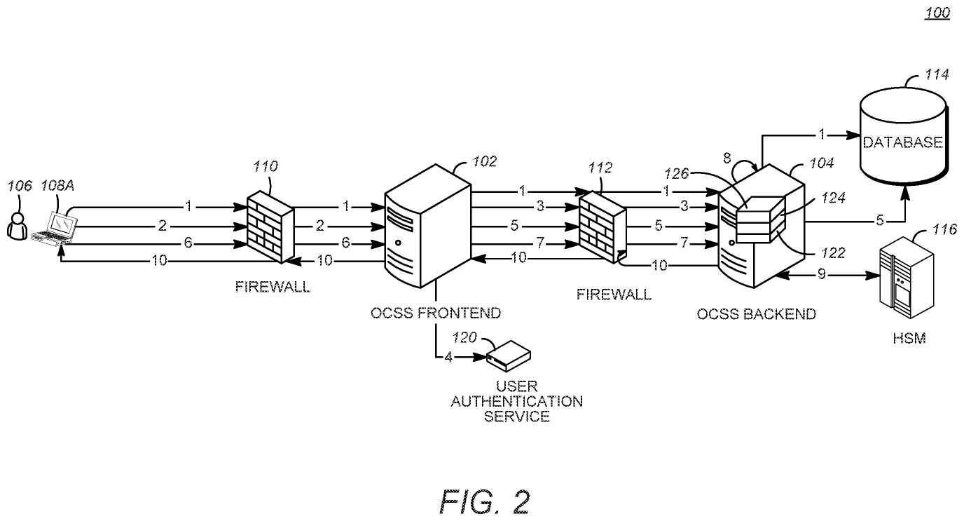

In a first embodiment, a manual code signing generation functionality is provided users 106. FIG. 2 is a diagram illustrating one embodiment of a manual process by which the designated human users of the OCSS 100 use to sign data.

Step 1: Before a user 106 can access the OCSS 100, an administrator of the OCSS 100 adds user's identity such as a username to the OCSS configurations (further described below) in OCSS database 114 corresponding to software development projects the user 106 has been assigned.

Step 2: The user 106 interacts with the OCSS frontend 102 via a web browser executing on a user device 108A (alternatively referred to hereinafter as an administrator client device). Preferably, this interaction is performed using the secure hypertext transfer protocol (HTTPS).

Step 3: The OCSS frontend 102 utilizes appropriate services provided by the OCSS backend 104 over a simple object access protocol (SOAP) interface.

Step 4: When the user 106 logs in, the OCSS frontend 102 validates the user credentials (e.g. username and password) received from the user device 108A against data stored in the OCSS User authentication service 120 and if the user credentials compare favorably with the data stored in the OCSS User authentication service 120, the user 106 is allowed to access the OCSS 100. If not, the user 106 is denied access to the OCSS 100.

Step 5: Based on logged in user's credential, the OCSS frontend 102 invokes BLL 122 of the OCSS backend 104 to look up user permissions to determine which configurations the logged in user has access to and presents only those configurations to the user 106.

Step 6: Using the user device 108A, the user 106 then selects one or more of the presented configurations and uploads an input/request file as well as other request parameters to OCSS frontend 102.

Step 7: The OCSS frontend 102 passes the uploaded input/request file, selected configuration, and operational details such as which signing key, signature algorithm, and/or digital signature format to use to OCSS backend 104.

Step 8: The OCSS backend 104, upon receiving request from the OCSS frontend 102, invokes the OCSS Service Layer 126.

Step 9: The invoked OCSS Service Layer 126 accesses the OCSS HSM 116 to get the keys that are needed to sign the data in the input/request file, and also retrieves configuration details from OCSS database 114. In one embodiment, the OCSS Service Layer 126 also parses the input file. This is required because for some signing operations, the input file has to follow a particular format, and this operation verifies that the input file is using the proper format, then retrieves certain information from certain portion(s) of input file. The OCSS Service Layer 126 then performs appropriate operations such as code signing, encryption, and decryption on the relevant portions of the input file. Based on these operations, the OCSS Service Layer 126 generates an output response file having the signed data and other information.

Step 10: The OCSS Service Layer 126 returns the generated output/response to the OCSS frontend 102. The OCSS frontend 102 generates a file from the generated output/response, which is forwarded to the user computer 108.

### Automated Machine-to-Machine Interface

Another embodiment provides the automatic signing generation functionality to customers such that they can integrate this in their automated build process. In order to provide such a mechanism a machine-to-machine interface must be provided over Internet such that OCSS machine user 108B can automatically connect with our OCSS 100 Service to request code signing. The OCSS system 100 has two types of users: human users 106 and machine users 108B. Both may have “user” role in the system, while only human user can have “manager” or administrator role. The machine to machine interface is for a OCSS machine user 108B to request code signing programmatically.

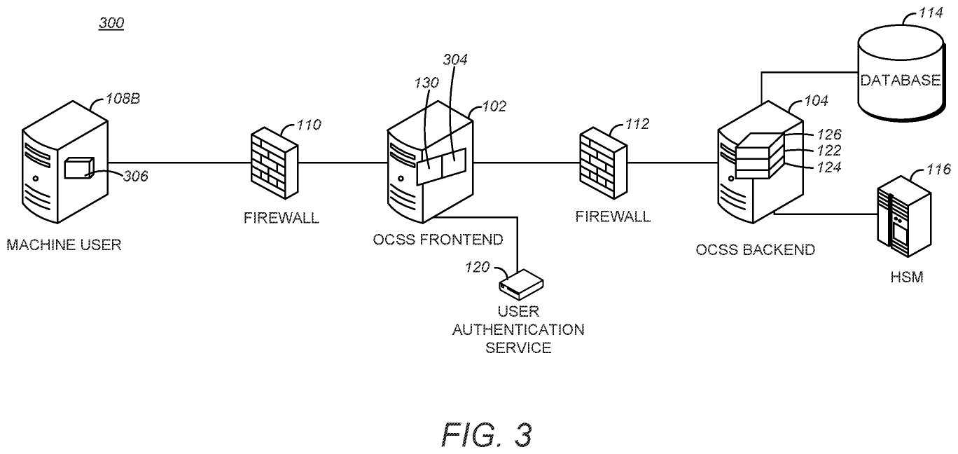

FIG. 3 is a diagram of an automated version of the OCSS 100. As described below, the automated OCSS 300 uses same OCSS architecture depicted in FIG. 1, and can be used to support automated online requests from a OCSS machine user 108B associated with an IP address. In this case, the IP address is treated as a virtual user of the OCSS 100 and can obtain the same kinds of permissions as are normally assigned to a human user 106.

The automated OCSS 100 introduces two new components: an OCSS client tool 306 implemented on an OCSS machine user 108B and an OCSS web service 304. The OCSS client tool 306 may be implemented in JAVA. The OCSS Web Service 304 provides an interface to the OCSS 100 infrastructure elements described above.

The automated OCSS 100 implements a machine-to-machine interface that comprises OCSS client tool 306, OCSS Web Service 304 and OCSS backend 104. OCSS backend 104 functionality is shared between the manual user access modes described with respect to FIG. 2 (e.g. graphical user interface or GUI), and the machine-to-machine interface described further below.

### OCSS Client

The OCSS machine user 108B utilizes an OCSS client 306 that comprises an executable written in a general purpose programming language that can be executed in virtually any environment, such as JAVA.

The OCSS client 306 that is executed in the OCSS machine user 108B environment handles any pre-processing and post-processing of image files of the data to be signed so the OCSS machine user 108B does not need to know the details of the signing operations being performed on such data. The OCSS client 306 communicates with the OCSS Web Service 304 which runs on OCSS frontend 102.

### OCSS Web Service

The OCSS web service 304 is hosted on OCSS frontend 102 behind firewall 110 to protect against unauthorized access. The OCSS web service 304 can be hosted in IIS and performs authorization and authentication functionality of OCSS 100 and does not include system and other crypto operation details. The OCSS web service 304 allows the OCSS client, through the OCSS frontend 102 to request code signing, encryption and decryption without a human interface or user 106 involvement.

### OCSS Machine-to-Machine Process

Before an OCSS machine user 108B can access OCSS 100, the OCSS administrator creates a user (machine) account in the OCSS User authentication service 120 and personalizes a hardware cryptographic token for that OCSS machine user 108B. The hardware cryptographic token can be used for OCSS machine user 108B authentication in a number of ways.

Once the OCSS machine user 108B is authenticated, the OCSS Web Service 304 invokes the OCSS backend 104 to retrieve machine authorization permission data that is used to determine whether the requesting machine account is authorized to perform the requested operation. Such authorization permission data is stored in the OCSS database 114.

Upon receiving the request from OCSS Web Service 304, the OCSS backend 104 invokes the OCSS Service Layer 126, which accesses the OCSS HSM 116 to retrieve the keys required for the data signing process and also retrieve configuration details for the configurations that the client is authorized to access or control. The OCSS backend 104 then optionally parses the input file provided by the OCSS machine user 108B above. The OCSS backend 104 then performs the appropriate action such as signing the code or other data in the input file, and/or encryption and decryption of data or keys. Based on the results of the action, the OCSS Service Layer 126 generates a response having the output or results of the requested action. This output may comprise, for example, the signed data, and/or encrypted or decrypted keys. The OCSS Service Layer 126 later returns this output to OCSS Web Service 304 executing on the OCSS frontend 102. The OCSS Web Service 304 returns the generated output to OCSS client 306. If no output is available, the OCSS web service 304 returns an error code.

The OCSS 100 is secured with multiple layers of protection against unauthorized access and protection of private keys including those used to sign the data. Such protection includes:
User access is controlled by providing a hardware crypto token to the OCSS machine user 108B. The hardware crypto token contains a certificate and a corresponding private key and is associated with a username and password. The private key may be used to decrypt a locally stored user password or for direct authentication to the OCSS.
User authorization is role-based and very flexible, allowing different roles including administrator, manager, or user. Machine user 108B can only be assigned “user” role.
The OCSS backend 104 is deployed in a secure area behind firewall 112 which allows access to the OCSS backend 104 only from the OCSS frontend 102 and in one embodiment, only on two web services ports, with access to a structured query language (SQL) server and the OCSS HSM 116 locked down.
Private keys are stored in OCSS HSM 116, and those keys cannot be retrieved in clear form. PKCS11 is an example of a standards-based HSM interface which may be used for code signing, encryption, and decryption operations, thus never exposing the private keys in clear form.
Critical operations are checked against authorization rules (stored in the OCSS database 114) and performed only if they are compliant with those rules.

Certificates are generated with the IP address of the OCSS machine user 108B as a unique user identifier in the CommonName attribute of each certificate. Optionally, a client is not permitted to be behind proxy settings, so that the OCSS machine user 108B IP address is the actual address and not modified as seen by the server. IP addresses may be blocked from accessing OCSS 100 configurations and entities based on the geographic location associated with that IP address.

### Management of Users

As described above, there is a need to provide a framework that allows different organizations or companies to structure their data signing permission needs as they see fit or to safely permit data signing by other independent organizations that publish the data to their customers. This is accomplished by defining a hierarchical organization of a plurality of entities within the OCSS, and managing eligibility to designate users to access those entities via accounts granting different eligibility status, as further described below.

An account represents the relation between a company and an OCSS entity and all of the children of the OCSS entity. An account is one of two account types, including an owner account type, and a participant account type. Granting an account provides eligibility to grant permission of a user to access an OCSS entity (and those hierarchically below that entity), but not permission itself. The permission is instead granted to the eligible user. A company may have multiple accounts for different OCSS entities, as further discussed below.

The top level OCSS entity (the application platform entity discussed below) can be owned by just one company through an owner account. This is enforced by the OCSS administrator granting an owner account to only one company. However, a company may have a participant account on the two top OCSS entity levels (the application platform entity and the project entity). This structure allows different OCSS entities to be accessible by multiple companies by the granting of the particular type of account (owner or participant).

Only users from an owner account can be assigned as a manager, and only users whose company has an account (either an owner account or a participant account) can be granted permission to sign data to be installed on devices associated with an entity associated with that account.

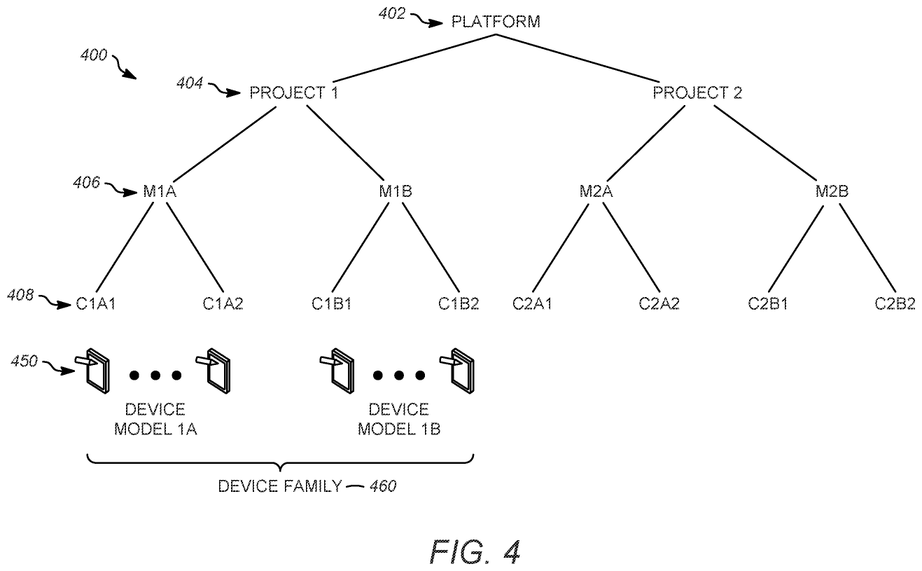

FIG. 4 is a diagram depicting a hierarchical organization (e.g. hierarchy 400) of a plurality of entities associated with data signing operations discussed above. The hierarchy 400 of entities includes, in decreasing hierarchical order, an application platform entity 402, at least one project entity 404 for each application platform entity 402, at least one model entity 406 for each project entity 404 and at least one configuration entity 408 for each model entity.

The application platform entity 402 may be evidenced by a corporate entity that manufactures or produces a plurality of devices 450, such as the assignee of this patent, COMMSCOPE, INC. A platform entity is defined as the highest hierarchical entity that organizes the code signing metadata/information for the fielded devices 450.

The project entity 404 typically comprises a family of devices 460 produced by the application platform entity 402. For example, the corporate entity COMMSCOPE may produce a first family of devices 406 such as set top boxes (STBs) for receiving satellite broadcasts (one project entity) and another family of devices 460 such as STBs for receiving cable broadcasts. Familial or group bounds can be defined as desired, but are typically defined to include products with analogous or similar functional requirements or functional architectures. For example, the project entity may be defined according to the functionality or source of the chip used in the devices 450—for example, those that use one particular digital telecommunication processing chip family belonging to one project and another digital telecommunication processing chip family in another project entity.

The model entity 406 can represent the particular models of the devices 450, for example models of satellite STBs and cable STBs. In the context of data signing, the model designation defines the how the signed data is to be installed on the devices 450 associated with the model entity 406. For example, a particular model of satellite STB may use a different technique for installing new data or code than a different model of the satellite STB. In the context of signing, the configuration entity defines the data to be installed on the devices 450.

For example, the satellite STB of the aforementioned example may include bootloader code (code that executes upon a system reboot that uploads and executes code and scripts), as well as application code. The one configuration entity may represent bootloader code, while a different configuration entity represents the application code.

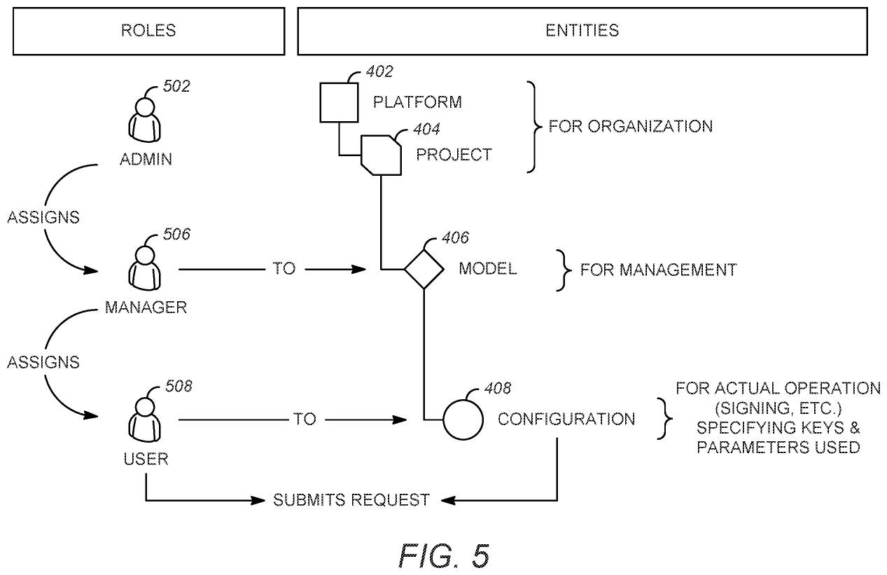

FIG. 5 is a diagram depicting the hierarchy 400 and the roles associated with those entities. An administrator 502 of the OCSS 100 is identified, and that administrator 502 is authorized to define the hierarchy of the entities in decreasing order, an application platform entity, at least one project entity for each application platform entity, at least one model entity for each project entity, and at least one configuration entity for each model entity. The administrator 502 is also authorized to access and authorize access to any of the entities 402-408 and may also assign a manager role 506 to another individual to manage a particular model entity 506. This individual (hereinafter alternatively referred to as the manager 506 of the model entity 406) is thus a person having the manager role 506 with respect to the associated model entity 406. This manager 506 is authorized to designate or assign user roles 508 to particular individuals for a particular configuration entity 408. This individual (herein alternatively referred to as a user 508 of a particular configuration entity 408) is thus a person having a user role 508 with respect to an associated configuration entity 408. Importantly, managers 506 may not add users (this can be accomplished only by the OCSS administrator), but authorize users to perform certain roles.

The configuration entity 408 holds information regarding the specific code signing operation such as signing keys, signature algorithm, file format, and other security parameters. Managers 506 are normally defined to have access to this configuration information for all the configurations under the manager's managed entity (model 406). Users who has access to a configuration entity 408 can use it to perform the code signing activity according to the specified information/parameter but normally do not see the detailed information (e.g. keys, algorithms, and the like) itself.

### Code Signing System Elements

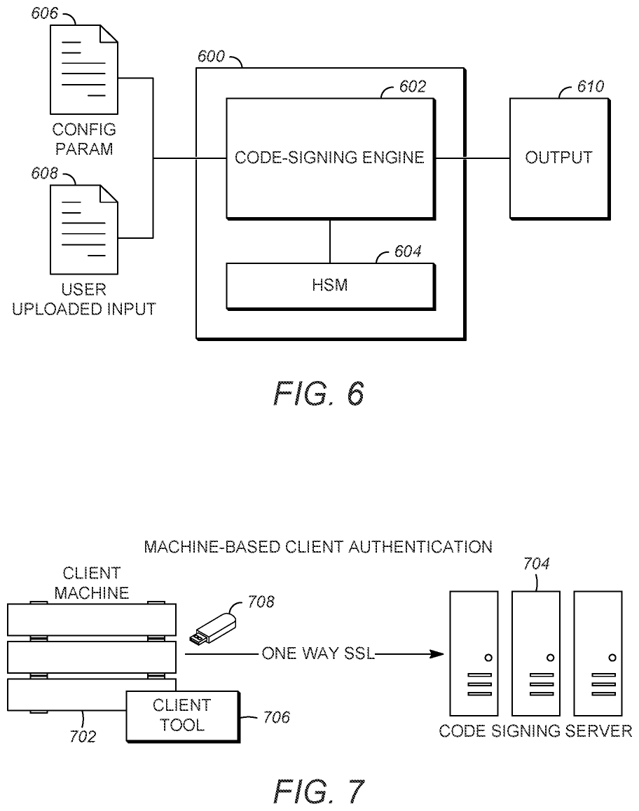

FIG. 6 is a diagram of elements of a general purpose machine-to-machine code signing system 600. The system 600 comprises a code signing engine 602. In one embodiment, the code signing engine 602 has built in code signing operations implemented as “operation types.” Operation types may include proprietary or standard crypto operations such as PKCS #1, PKCS #7. The system 600 may also include an HSM 604. Any cryptographic keys for signing and encryption are preferably protected in the HSM 604 accessible by the Code Signing Engine 602 via an API.

Before a client can use the code signing system 1000, a “configuration” is defined (typically by a system administrator described above). The configuration defines the operation type, the key, and any standard parameters defined by the operation type. For example, the PKCS #1 operation type may require am RSA signing key, and standard parameters may include the Endianness of the operation and what hashing algorithm to use (for example, SHA1 or SHA256).

Once the configuration is defined and authorized to a client, the client can sign code by submitting a request with a pointer to the configuration and the input code image to the system. The code signing engine 602 accepts the configuration parameters 606 and the user uploaded input data to be signed 608, and executes the code implemented for that operation type over the configuration parameters and input image in the request, to create the final output image 610 to return to the client.

There are different ways to organize signing configurations. One such way is to use a hierarchy structure such as the one illustrated in FIG. 5, discussed above. The configurations are organized in a hierarchy structure starting from Platform 402, followed by project 404, model 406 and then the actual configurations 408. Users of the code signing system may be assigned different roles. In this example, the Administrator 502 is responsible for defining the various entities in the system and assigning users 508 as manager 506 to models 406. The managers 506 are responsible for assigning users 508 (machine clients in this case) to the actual signing configurations. And finally, machine client 108B can submit signing requests to authorized configurations to perform signing operations.

FIG. 7 is a diagram illustrating the use of a client tool 706 and a code signing system 704 for use in signing software images and/or other data. The client tool 706 is implemented to execute on a client machine 702 which communicates with the OCSS 100 over a communication channel. The communication between the client machine 702 and the OCSS 100 may be implemented with secure socket layer (SSL) communications for security. Mutual authentication may be achieved wherein the client machine 702 authenticates the OCSS 100 based on the server's certificate, and the client machine 702 is authenticated to the OCSS 100 via message signature generated using a unique private key and certificate loaded in a secure device such as a USB Crypto Token 708 previously issued for use with the client machine 702. Alternatively, a two-way SSL connection can be set up where in both sides use their certificates to authenticate the SSL handshake.

The client tool 706 is capable of submitting code signing request to the OCSS 100, providing information comprising a pointer to the code signing configuration (stored at the OCSS 100), input image, and any optional parameters required for the operation to be performed. The interface to the OCSS 100 may be implemented using any protocols, one common choice is the SOAP (Simple Object Access Protocol), which is an XML based protocol over HTTPS. The message is signed by the unique private key in the USB Crypto Token 708. The OCSS 100 verifies the message signature to make sure it is authenticated. The OCSS 100 then verifies that the client machine 702 machine (identified by the token's certificate) is authorized for the requested signing configuration. If so, the OCSS 100 processes the code signing request and return the result to the client machine 702.

As described above, there are typically some processing steps to be performed before and after the signature is generated by the OCSS 100. These processing steps may be implemented on the OCSS 100 side, in which case the full software image must be uploaded to the OCSS 100 for processing. When the software image size is large, this process is time consuming and the transmission may be interrupted if the communication link is unreliable.

### Distributed Code Signing System

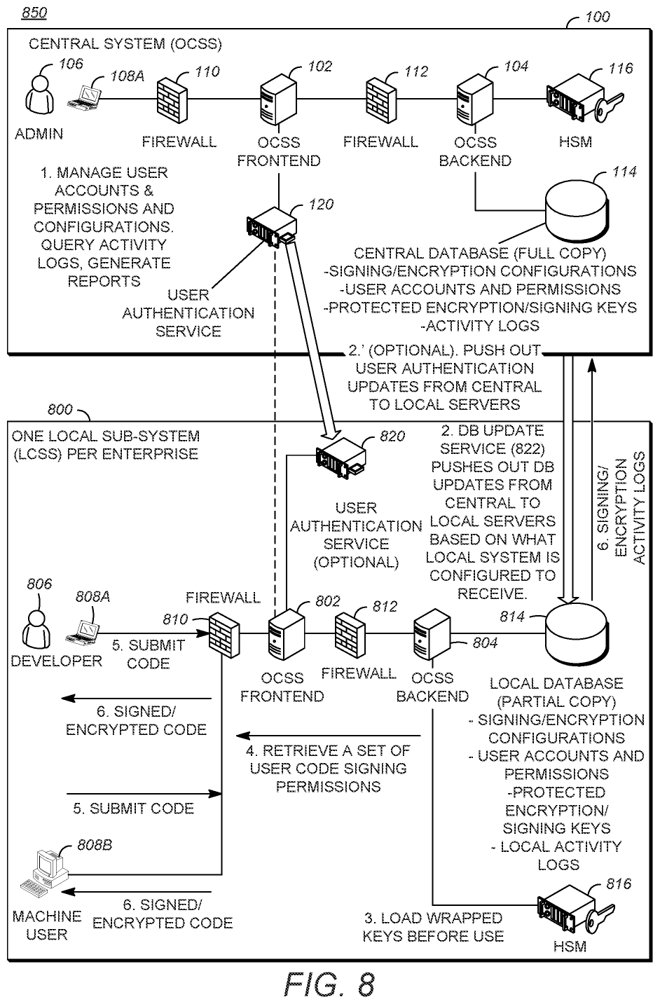

FIG. 8 is a diagram of one embodiment of a distributed code signing system (DCSS) 850. The DCSS 850 comprises the OCSS 100 and a local code signing subsystem (LCSS) 800. The LCSS 800 may be one of a plurality of LCSSs 800, each associated with an enterprise that desires to sign data.

The elements of the OCSS 100 are as described above. The LCSS 800 comprises an LCSS front end 802 that includes a GUI layer that provides a presentation layer for the LCSS 800 as well as a service layer which enables communication with machine users. In the illustrated embodiment, the LCSS front end 802 is hosted on a server that is behind firewall 810 to protect against unauthorized access. Like the OCSS frontend 102, the LCSS front end 802 comprises a web portal interface that implements the presentation functionality of user device 808A to an external user such as developer 806. The LCSS front end 802 controls access to the LCSS backend 804 and the LCSS backend 804 performs the functionality of enforcing signing permissions, performing code signing or key generation. Like the OCSS frontend 102, the LCSS front end 802 optionally has access to an LCSS user authentication service 820 to authenticate valid users such as 806. Machine users such as device 808B are authenticated directly by the front end 802 based on verification of a digital signature. User authentication updates may be transmitted from the OCSS user authentication service 120 to the LCSS user authentication service 820 on as needed or on a periodic basis to support authentication within the LCSS 800. As with the OCSS 100, the developer 806 must specify user credentials to access the LCSS 800. Alternatively, LCSS front end 802 may access the centralized user authentication service 120 in order to authenticate valid user devices.

The LCSS backend 804 sits behind a second LCSS firewall 812 and provides protected access to LCSS database 814 and code signing keys are stored in the LCSS HSM 816. It is also used to access OCSS hierarchical entities and to look up user permissions for different code signing configurations and to perform the crypto operations of the LCSS 800. The LCSS backend 804 connects to the LCSS HSM 116 an using the LCSS HSM 116, performs operations such as code signing, encryption, and decryption.

The LCSS database 814 stores signing and/or encryption configurations, user accounts and related permissions, protected signing keys, encryption keys or both signing and encryption keys, and optional activity logs for the particular user or group of users 806 within the enterprise associated with the LCSS 800. The LCSS backend 804 is communicatively coupled to a LCSS HSM 816 that stores a wrapping key Kw that is used to decrypt or unwrap signing keys Ks and encryption keys Ke.

As was true with the OCSS 100, the LCSS 800 may be implemented with a single server performing the functions of both the OCSS frontend 102 and the OCSS backend 104, albeit, with reduced security. Also, the LCSS 800 supports manual interactive web processes using the developer 806 using user device 808A) and automated machine-to-machine processes using the machine user device 808B. Such manual or automatic processes are performed are outlined above.

A summary of an exemplary procedure to sign data is indicated by the numbered steps of FIG. 8. In step (1), the administrator 106 uses the administrator client device 108A to interface with OCSS database 114 through the OCSS frontend 102 and OCSS backend 104 to create and manage user accounts, permissions, and code signing/encryption configurations, as well as to query activity logs and generate activity reports, largely in the same way as this is accomplished in a centralized data signing architecture. These user accounts, permissions, and configurations are stored in OCSS database 114, as well as protected (e.g. encrypted) signing keys Ks, which are retrieved from the OCSS HSM 116 and encrypted before storage for later distribution to the LCSS database 814. For simplicity purposes, only an administrator user 106 is depicted for the OCSS 100, the OCSS 100 is capable of allowing non-administrator users to (such as a “developer” or machine user) to sign code using the OCSS 100 as well.

In step (2A) selected portions or all of the OCSS database 114 is pushed to one or more LCSS databases 814 that is accessible to at least an associated one of the user client device(s) 808. This can be performed, for example, by a database update service 822. The database update service 822 may be implemented by one or both of the OCSS backend 104 or the LCSS backend 804, depending on whether the selected portions are pushed or pulled. Preferably, the update is performed over encrypted virtual private network (VPN) connections to both databases since they are behind each backend 104, 804 and not exposed to general Internet traffic. Alternatively, the database update service 822 routes its messages to the OCSS database 114 through the OCSS frontend 102, firewall 112 and OCSS backend 104, avoiding the need to setup a VPN connection. Similarly, database update service 822 may route its messages to the LCSS database 814 through the LCSS frontend 802, firewall 812 and LCSS backend 804, avoiding the need to setup a VPN connection to each customer with an LCSS. These selected portions depend upon what the LCSS 800 is configured to receive and generally includes wrapped signing keys Ks and/or encryption keys Ke that are later unwrapped and for use in signing data, as well as user information, configuration information and permissions. Step 2B illustrates an optional step of pushing user authentication updates from the OCSS user authentication service 120 to the LCSS user authentication service 820 so that this information can be used to locally authenticate users of the LCSS 800. When the optional local user authentication service 820 is not available, the LCSS frontend utilizes the centralized OCSS user authentication service 120 to validate a user identity.

In step (3), the wrapped encryption or signing keys are securely loaded into the LCSS HSM 816 internal memory. The retrieval and/or decryption of the wrapped signing/encryption keys may take place in response to a request to sign data and the decrypted signing/encryption keys thereafter be deleted, or may take place in advance and be retained in secure storage of the second HSM 814. In step (4), the LCSS frontend 802 at this time retrieves a set of user code signing permissions from the LCSS backend 804. These permissions are utilized to present the user (developer 806) only with the set of code signing/encryption configurations for which that user is authorized.

In step (5) the client (in the illustrated example, a software developer 806) submits data such as code for signing using device 808A, or the data is submitted by machine user 808B. The request specifies a particular configuration that includes the code signing format, IDs of code signing and encryption keys and any other parameters associated with that configuration. LCSS frontend 802 verifies that the user submitting this request is authorized for the specified configuration. Submitted code or a hash of the code is securely routed from the LCSS frontend 802 to the LCSS backend 804 (through the firewall 812). The hash of the code is submitted to the LCSS HSM 816 for signing and the whole code image may also be submitted to LCSS HSM 816 for encryption with another cryptographic key in the LCSS HSM 816.

In step (6), after retrieving and unwrapping the signing/encryption keys, the LCSS backend device 804 signs the data and returns the signed/encrypted code. The result is routed back to the LCSS backend 804, then to the LCSS frontend 802 (through the firewall 812) and finally back to the client machine 808A or 808B for local storage.

In step (7), activity logs describing the signing/encryption processes performed is transmitted to the OCSS database 114 with the help of the database update service 822, preferably over encrypted VPN connections to both databases. Alternatively, the database update service 822 routes its messages to the OCSS database 114 through the OCSS frontend 102, firewall 112 and OCSS backend 104. Similarly, database update service 822 may route its messages to the LCSS database 814 through the LCSS frontend 802, firewall 812 and LCSS backend 804.

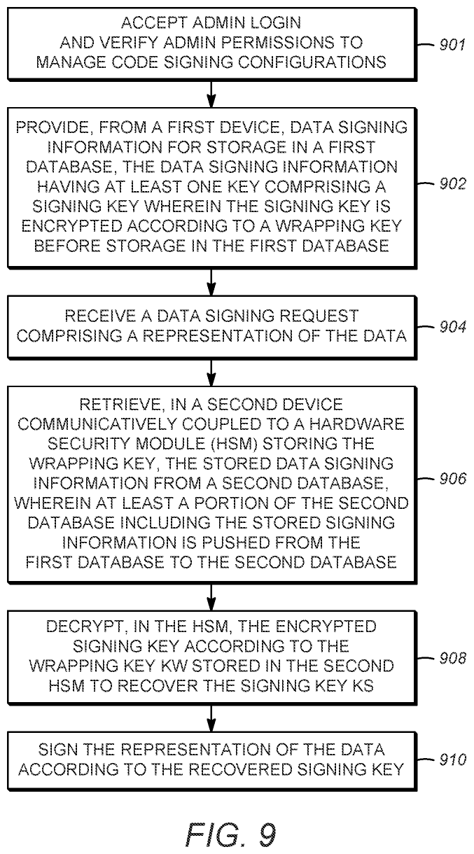

FIG. 9 is a diagram illustrating further details of exemplary operations that can be used to sign data. The administrator 106 first provides in step 901 his/her user credentials (e.g., username and password) to the OCSS frontend 802 for verification and for an authorization check that this user is authorized to manage code signing configurations. The administrator 106 subsequently uses the LCSS frontend 802 to define user accounts, permissions, and configurations.

In block 902, data signing information is provided from the LCSS frontend 802 for storage in the first database 114. The data signing information comprises identifiers (such as a key label, name, or a numeric identifier) for a signing key Ks (used to sign the data), for one or more encryption keys Ke (used to encrypt the data), or both for the signing key and the one or more encryption keys Ke. For simplicity, we assume in the below discussion that the one or more keys includes only the signing key Ks. A key identifier can later be utilized to retrieve a wrapped/encrypted key from the database or alternatively point to a key object which is already unwrapped inside an HSM. For example, the data signing information may also include user account information having data signing permissions, and at least one data signing configuration, as described above. The data signing information is received by the OCSS database 114 and stored.

In a preferred embodiment, the signing key Ks (and encryption key(s) Ke, if included) is encrypted according to a wrapping key Kw before storage by the OCSS database 114. Ks and/or Ke may be obtained from an external source or randomly generated inside the OCSS HSM 116. In one embodiment, the encryption may be performed by OCSS HSM 116 before transmission to the OCSS database 114. In this embodiment, the wrapping key Kw used to encrypt the signing key Ks may be stored in the OCSS HSM 116. In another embodiment, an encrypted signing key E_{Kw}[Ks] is randomly generated without the use of the wrapping key Kw, which is possible, for example, with an Elliptic Curve crypto system. An encrypted encryption key (if needed) E_{Kw}[Ke] is also randomly generated without the knowledge of Kw or a need to perform encryption. The generated E_{Kw}[Ks] and E_{Kw}[Ke] (generated as random numbers) are then stored in the OCSS database 114.

If Ks was generated somewhere within the OCSS 100 (was not obtained from an external source), a public signature verification key Kv that corresponds to Ks may then be derived from decrypted Ks inside the HSM 116, extracted from the HSM 116 and provided to a software developer 806 out of band. Kv is needed inside a device to later validate code signatures generated by Ks. Decryption key Kd that corresponds to Ke generated within the OCSS 100 may also be derived from decrypted Ke inside the HSM 116, extracted from the HSM 116[, and provided to a software developer 806 out of band so that a device can later decrypt and execute encrypted code images stored in the device. Kd may be the same secret key as Ke.

In another embodiment, the wrapping key Kw is available to the OCSS database 114 (pre-stored in the OCSS backend 104 or OCSS database 114 or included with the data signing information), and the encryption of the signing key Ks is performed by another processor (e.g. user device 108A) after the signing key Ks is received and before the signing key Ks is stored. In either case, communications between the user device 108A, OCSS frontend 102, OCSS backend 104 and the OCSS database 114 may be protected by encryption or other means to prevent unauthorized access to the keys transmitted across interfaces.

At least a portion of the OCSS database 114 contents having the stored data signing information and wrapped signing key E_{Kw}[Ks] is retrieved from the OCSS database 114 and securely sent to the LCSS database 814 by the database update service 822. In one embodiment, the entire contents of the OCSS database 114 is pushed (e.g. transferred by the database update service 822) to the LCSS database 814. In other embodiments, only that portion of the OCSS database 114 for which the user client device 808 is permitted to provide data signing or encryption services is pushed from the OCSS database 114 to the LCSS database 814. The LCSS database 814 is accessible to LCSS backend 804. The time at which the at least a portion of the OCSS database contents is pushed to the LCSS database 814 can be determined in different ways. In one embodiment, the at least a portion of the contents of the OCSS database 114 is pushed to the LCSS database 814 on a periodic basis (e.g. every day). In another embodiment, the at least a portion of the contents of the OCSS database 114 is pushed to the LCSS database 814 according to a threshold amount of information has been added to or removed from the OCSS database 114. In this embodiment, the contents of the OCSS database 114 is only pushed to the LCSS database 814 if a threshold value of changes to relevant portions of the LCSS database 814 have been made since the last time the contents was pushed to the LCSS database 814. This threshold value may be a number of changes or a data size of the changes. Pushing the data may also be accomplished according to a priority hierarchy, where in which high priority changes (e.g. additions or deletions to the information provided by the administrator 106 to the OCSS database 114 are immediately pushed to the LCSS database 814). Finally, although it affects responsiveness, other embodiments may employ a data pulling construct where in addition to data being pushed from the OCSS database 114 to the LCSS database 814, a request by the user client device(s) 808 that do not have the suitable user account and permissions, configurations, signing key(s), or encryption key(s) triggers the DB Update Service 822 to initiate transmission of that portion of the OCSS database 114 associated with that user client device(s) 808 to the LCSS database 814 for storage.

When data signing services are desired, the developer 806 (using device 808A) or machine user 808B generates a data signing request. The data signing request is provided to the LCSS backend 804 via the LCSS frontend 802, as shown in block 904. The generated data signing request includes a representation of the data to be signed. This representation may include for example, the data itself, or a computed digest of the data such as a hash. The data itself may comprise data of any type, including a software image or software code, or a configuration message having data used to control another device such as a computer or processor communicatively coupled to the user client device 808A or 808B.

LCSS backend 804 communicates with the LCSS database 814 to retrieve the stored data signing information, which includes the wrapped signing key E_{Kw}[Ks]. This is shown in block 906. Using the wrapping key Kw, this encrypted signing key E_{Kw}[Ks] is decrypted to recover the signing key Ks, as shown in block 908.

In one embodiment, the encrypted signing key E_{Kw}[Ks] is decrypted and securely stored in the LCSS HSM 816 according to the wrapping key Kw for later use upon receiving the pushed portion of the content of the LCSS database 814. This saves the time and processing required to decrypt the encrypted signing key E_{Kw}[Ks] when a data signing request is received. However, additional security is offered in an alternative embodiment in which the encrypted signing key E_{Kw}[Ks] is decrypted only after a data signing request is received, and further security obtained if the decrypted signing key Ks is deleted or erased after being used to sign the representation of the data.

In one embodiment, the decryption of the encrypted signing key E_{Kw}[Ks] is performed in the LCSS HSM 816 and the decrypted signing key Ks remains stored within and is never provided external to the LCSS HSM 816. The LCSS backend 804 makes indirect use of Ks by submitting to it data to be signed, thus preventing both the wrapping key Kw and the signing key Ks from being exposed. Once the signing key Ks has been recovered, it is used by the LCSS HSM 816 to sign the representation of the data, as shown in block 910.

As discussed above, data signing information may comprise an encryption key Ke that allows the user to encrypt, as well as sign the data. In this instance, the data signing request further includes a request to encrypt the data, and the encryption key Ke is encrypted according to the wrapping key Kw before storage in the OCSS database 114. Thus, the stored data signing information further comprises the encrypted encryption key E_{Kw}[Ke], and to encrypt the data as requested, the encrypted encryption key E_{Kw}[Ke] is decrypted using the wrapping key Kw to recover the encryption key Ke inside the LCSS HSM 816, and the data is thereafter decrypted inside the LCSS HSM 816 according to the recovered encryption key Ke.

### Hardware Environment

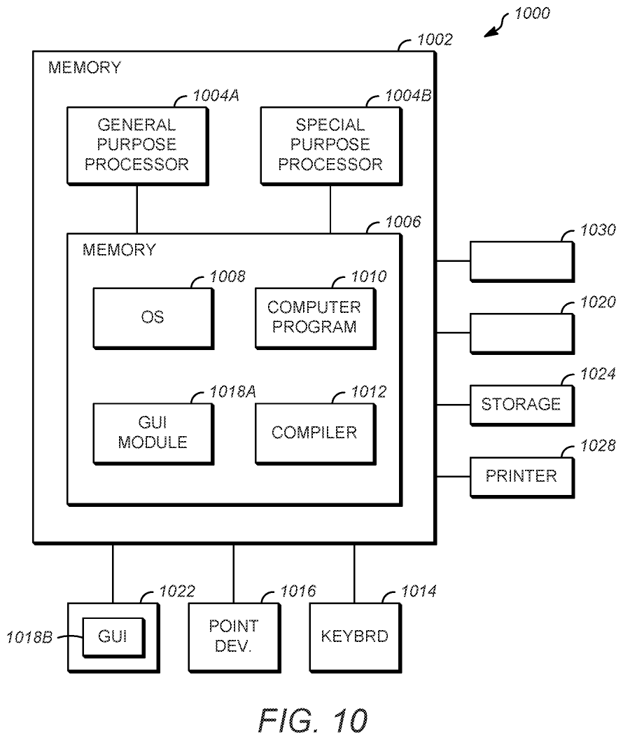

FIG. 10 illustrates an exemplary computer system 1000 that could be used to implement processing elements of the above disclosure, including the user client devices 108 and 808, the firewalls 100, 810, 112, and 812, the OCSS and LCSS frontends 102 and 802, the OCSS and LCSS HSMs 116 and 816, the OCSS and LCSS backends 104 and 804, the OCSS and LCSS databases 114 and 814, and the user authentication services 120 and 820. The computer 1002 comprises a processor 1004 and a memory, such as random access memory (RAM) 1006. The computer 1002 is operatively coupled to a display 1022, which presents images such as windows to the user on a graphical user interface 1018B. The computer 1002 may be coupled to other devices, such as a keyboard 1014, a mouse device 1016, a printer 1028, etc. Of course, those skilled in the art will recognize that any combination of the above components, or any number of different components, peripherals, and other devices, may be used with the computer 1002.

Generally, the computer 1002 operates under control of an operating system 1008 stored in the memory 1006, and interfaces with the user to accept inputs and commands and to present results through a graphical user interface (GUI) module 1018A. Although the GUI module 1018B is depicted as a separate module, the instructions performing the GUI functions can be resident or distributed in the operating system 1008, the computer program 1010, or implemented with special purpose memory and processors. The computer 1002 also implements a compiler 1012 which allows an application program 1010 written in a programming language such as COBOL, C++, FORTRAN, or other language to be translated into processor 1004 readable code. After completion, the application 1010 accesses and manipulates data stored in the memory 1006 of the computer 1002 using the relationships and logic that was generated using the compiler 1012. The computer 1002 also optionally comprises an external communication device such as a modem, satellite link, Ethernet card, or other device for communicating with other computers.

In one embodiment, instructions implementing the operating system 1008, the computer program 1010, and the compiler 1012 are tangibly embodied in a computer-readable medium, e.g., data storage device 1020, which could include one or more fixed or removable data storage devices, such as a zip drive, floppy disc drive 1024, hard drive, CD-ROM drive, tape drive, etc. Further, the operating system 1008 and the computer program 1010 are comprised of instructions which, when read and executed by the computer 1002, causes the computer 1002 to perform the operations herein described. Computer program 1010 and/or operating instructions may also be tangibly embodied in memory 1006 and/or data communications devices 1030, thereby making a computer program product or article of manufacture. As such, the terms “article of manufacture,” “program storage device” and “computer program product” as used herein are intended to encompass a computer program accessible from any computer readable device or media.

Those skilled in the art will recognize many modifications may be made to this configuration without departing from the scope of the present disclosure. For example, those skilled in the art will recognize that any combination of the above components, or any number of different components, peripherals, and other devices, may be used.

### CONCLUSION

This concludes the description of the preferred embodiments of the present disclosure.

The foregoing discloses an apparatus, method, and system for signing data. In one embodiment, the method comprises providing, from a first device, data signing information for storage in a first database, the data signing information having at least one key comprising a signing key Ks, wherein the signing key Ks is encrypted according to a wrapping key Kw before storage in the first database; receiving a data signing request comprising a representation of the data; retrieving, in a second device communicatively coupled to an hardware security module (HSM) storing the wrapping key Kw, the stored data signing information from a second database, wherein at least a portion of the second database including the stored signing information is pushed from the first database to the second database; decrypting, in the HSM, the encrypted signing key according to the wrapping key Kw stored in the HSM to recover the signing key Ks; and signing the representation of the data according to the recovered signing key.

Implementations may include one or more of the following features:

Any of the methods described above, wherein: the first signing key Ks is decrypted and utilized for signing data inside the HSM communicatively coupled to the first device.

Any of the methods described above, wherein: the wrapping key Kw is included in the data signing information.

Any of the methods described above, wherein: the at least a portion of the first database is pushed to the second database includes only that portion of the first database for which the second device is permitted to provide data signing services.

Any of the methods described above, wherein: the representation of the data includes the data or a hash of the data.

Any of the methods described above, wherein: the data signing request is received via a manual graphical user interface or an automated interface.

Any of the methods described above, wherein: the encrypted signing key is decrypted according to the wrapping key Kw upon receiving the pushed at least a portion of the first database and securely storing the decrypted signing key in the HSM for later use.

Any of the methods described above, wherein: the encrypted signing key is decrypted within the HSM according to the wrapping key Kw upon receiving the data signing request; and the method further includes erasing the decrypted signing key Ks after signing the representation of the data.

Any of the methods described above, wherein: the data signing information further includes at least one encryption key Ke; the data signing request further includes a request to encrypt the data; the encryption key Ke is encrypted according to the wrapping key Kw before storage in the first database; the stored data signing information further includes the encrypted encryption key Ke; the method further includes: decrypting, in the HSM, the encrypted encryption key Ke according to the wrapping key Kw stored in the HSM to recover the at least one encryption key Ke; and encrypting the data within the HSM according to the recovered encryption key Ke.

Any of the methods described above, wherein: the data includes a configuration message having data for controlling the second device.

Another embodiment is evidenced by system comprising means for performing the foregoing operations.

Another embodiment is evidenced by an apparatus for signing data, including: a first device, including: a first processor, a first memory, communicatively coupled to the first processor, the memory storing first processor instructions including first processor instructions for: providing, from the first device, data signing information for storage in a first database; the data signing information including: at least one key including a signing key Ks, user account information having data signing permissions; at least one data signing configuration; and wherein the signing key Ks is encrypted according to a wrapping key Kw before storage in the first database; a second device, including: a second processor; a second memory, communicatively coupled to the second processor, the second memory storing second processor instructions including second processor instructions for: receiving a data signing request including a representation of the data; retrieving, in the second device communicatively coupled to a hardware security module (HSM) storing the wrapping key Kw, the stored data signing information from a second database, wherein at least a portion of the second database including the stored signing information is pushed from the first database to the second database; decrypting, the encrypted signing key according to the wrapping key Kw to recover the signing key Ks within the HSM; and signing the representation of the data within the HSM according to the recovered signing key.

Implementations may include one or more of the following features:

Any apparatus described above, wherein: the wrapping key Kw is included in the data signing information.

Any apparatus described above, wherein: the at least a portion of the first database is pushed to the second database includes only that portion of the first database for which the second device is permitted to provide data signing services.

Any apparatus described above, wherein the representation of the data comprises the data or a hash of the data.

Any apparatus described above, wherein: the encrypted signing key is decrypted according to the wrapping key Kw within the HSM upon receiving the pushed at least a portion of the first database and securely storing the decrypted signing key in the HSM for later use.

Any apparatus described above, wherein: the encrypted signing key is decrypted within the HSM according to the wrapping key Kw upon receiving the data signing request; and the second processor instructions further comprise second processor instructions for erasing the decrypted signing key Ks within the HSM after signing the representation of the data.

Any apparatus described above, wherein: the data signing information further comprises at least one encryption key Ke; the data signing request further includes a request to encrypt the data; the encryption key Ke is encrypted according to the wrapping key Kw before storage in the first database; the stored data signing information further comprises the encrypted encryption key Ke; the second processor instructions further comprise second processor instructions for: decrypting, in the HSM, the encrypted encryption key Ke according to the wrapping key Kw stored in the HSM to recover the at least one encryption key Ke; and encrypting the data within the HSM according to the recovered encryption key Ke.

Any apparatus described above, wherein: the data comprises a configuration message having data for controlling the second device.

The foregoing description of the preferred embodiment has been presented for the purposes of illustration and description. It is not intended to be exhaustive or to limit the disclosure to the precise form disclosed. Many modifications and variations are possible in light of the above teaching. It is intended that the scope of rights be limited not by this detailed description, but rather by the claims appended hereto.

What is claimed is:

1. A method of signing data, comprising:
providing, from a first device, data signing information for storage in a first database; the data signing information comprising:
at least one key comprising a signing key Ks,
user account information having data signing permissions;
at least one data signing configuration; and
wherein the signing key Ks is encrypted according to a wrapping key Kw before storage in the first database;
receiving a data signing request comprising a representation of the data;
retrieving, in a second device communicatively coupled to a hardware security module (HSM) storing the wrapping key Kw, the stored data signing information from a second database, wherein at least a portion of the second database including the stored signing information is pushed from the first database to the second database;
decrypting the encrypted signing key according to the wrapping key Kw to recover the signing key Ks; and
signing the representation of the data according to the recovered signing key.

2. The method of claim 1, wherein:
first signing key Ks is decrypted and utilized for signing data inside the HSM communicatively coupled to the first device.

3. The method of claim 1, wherein the wrapping key Kw is included in the data signing information.

4. The method of claim 1, wherein:
the at least a portion of the first database is pushed to the second database includes only that portion of the first database for which the second device is permitted to provide data signing services.

5. The method of claim 1, wherein:
the representation of the data comprises the data or a hash of the data.

6. The method of claim 1, wherein the data signing request is received via a manual graphical user interface or an automated interface.

7. The method of claim 1, wherein the encrypted signing key is decrypted according to the wrapping key Kw upon receiving the pushed at least a portion of the first database and securely storing the decrypted signing key in the HSM for later use.

8. The method of claim 1, wherein:
the encrypted signing key is decrypted within the HSM according to the wrapping key Kw upon receiving the data signing request; and
the method further comprises erasing the decrypted signing key Ks after signing the representation of the data.

9. The method of claim 1, wherein:
the data signing information further comprises at least one encryption key Ke;
the data signing request further includes a request to encrypt the data;
the encryption key Ke is encrypted according to the wrapping key Kw before storage in the first database;
the stored data signing information further comprises the encrypted encryption key Ke;
the method further comprises:
decrypting, in the HSM, the encrypted encryption key Ke according to the wrapping key Kw stored in the HSM to recover the at least one encryption key Ke; and
encrypting the data within the HSM according to the recovered encryption key Ke.

10. The method of claim 1, wherein the data comprises a configuration message having data for controlling the second device.

11. An apparatus for signing data, comprising:
a first device, comprising:
a first processor,
a first memory, communicatively coupled to the first processor, the memory storing first processor instructions comprising first processor instructions for:
providing, from the first device, data signing information for storage in a first database; the data signing information comprising:
at least one key comprising a signing key Ks,
user account information having data signing permissions;
at least one data signing configuration; and
wherein the signing key Ks is encrypted according to a wrapping key Kw before storage in the first database;
a second device, comprising:
a second processor;
a second memory, communicatively coupled to the second processor, the second memory storing second processor instructions comprising second processor instructions for:
receiving a data signing request comprising a representation of the data;
retrieving, in the second device communicatively coupled to a hardware security module (HSM) storing the wrapping key Kw, the stored data signing information from a second database, wherein at least a portion of the second database including the stored signing information is pushed from the first database to the second database;
decrypting, the encrypted signing key according to the wrapping key Kw to recover the signing key Ks within the HSM; and
signing the representation of the data within the HSM according to the recovered signing key.

12. The apparatus of claim 11, wherein the wrapping key Kw is included in the data signing information.

13. The apparatus of claim 11, wherein:
the at least a portion of the first database is pushed to the second database includes only that portion of the first database for which the second device is permitted to provide data signing services.

14. The apparatus of claim 11, wherein:
wherein the representation of the data comprises the data or a hash of the data.

15. The apparatus of claim 11, wherein the encrypted signing key is decrypted according to the wrapping key Kw within the HSM upon receiving the pushed at least a portion of the first database and securely storing the decrypted signing key in the HSM for later use.

16. The apparatus of claim 11, wherein:
the encrypted signing key is decrypted within the HSM according to the wrapping key Kw upon receiving the data signing request; and
the second processor instructions further comprise second processor instructions for erasing the decrypted signing key Ks within the HSM after signing the representation of the data.

17. The apparatus of claim 11, wherein:
the data signing information further comprises at least one encryption key Ke;
the data signing request further includes a request to encrypt the data;
the encryption key Ke is encrypted according to the wrapping key Kw before storage in the first database;
the stored data signing information further comprises the encrypted encryption key Ke;
the second processor instructions further comprise second processor instructions for:
decrypting, in the HSM, the encrypted encryption key Ke according to the wrapping key Kw stored in the HSM to recover the at least one encryption key Ke; and
encrypting the data within the HSM according to the recovered encryption key Ke.

18. The apparatus of claim 11, wherein the data comprises a configuration message having data for controlling the second device.

19. A system for signing data, comprising:
means for providing, from a first device, data signing information for storage in a first database, the data signing information comprising:
at least one key comprising a signing key Ks;
user account information having data signing permissions;
at least one data signing configuration;
wherein the signing key Ks is encrypted according to a wrapping key Kw before storage in the first database; and
means for receiving a data signing request comprising a representation of the data;
retrieving, in a second device communicatively coupled to a hardware security module (HSM) storing the wrapping key Kw, the stored data signing information from a second database, wherein at least a portion of the second database including the stored signing information is pushed from the first database to the second database;
means for decrypting the encrypted signing key according to the wrapping key Kw to recover the signing key Ks within the HSM; and
means for signing the representation of the data according to the recovered signing key.

20. The system of claim 19, wherein:
first signing key Ks is decrypted and utilized for signing data inside the HSM communicatively coupled to the first device.
